(19) United States
(12) Patent Application Publication
(10) Pub. No.: US 2008/0284983 A1
(43) Pub. Date: Nov. 20, 2008

(54) Mobile Digital Media Display System

(76) Inventor: Phillip Richard Dula, Fayetteville, NC (US)

Correspondence Address: Rick Dula, 1994 Fairforest Drive, Fayetteville, NC, 28304, US

(21) Appl. No.: 11/749,233

(22) Filed: May 16, 2007

Related U.S. Application Data
(60) Provisional application No. 60/747,669.

(51) Int. Cl. G03B 29/00

(52) U.S. Cl. 352/131

(57) ABSTRACT

Abstract: A large format communication display system designed and constructed for viewing from extended distances. In accordance with the present invention, using opto-electronic devices, full motion digital video images are projected from within a partially or totally enclosed conveyance on to wall mounted display screens designed for viewing outside a conveyance, while the conveyance is in motion or parked. The general idea of this invention is to remove the barrier of no video or no motion images from mobile or transit displays. The self-contained or modular aspect of this invention allows complete portability and viewing while in transit or on site.

### PERSONALLY SPONSORED RESEARCH

Not Applicable

### SEQUENCE LISTING OR PROGRAM

Not Applicable

### BACKGROUND

1. Field of Invention

The invention relates to the design, development and utility of a portable and modular media display system for communication through viewing of information in various visual formats. As required, here I am referencing the related provisional patent number 60747669, dated May 19, 2006.

### BACKGROUND

2. Description of Prior Art

Outdoor advertising is a growth industry and is as old as business itself. From the beginning banners, placards and all forms of signage have served to announce, notify and inform. Before the establishment of the written language, characters were drawn for public viewing to communicate with others. These displays were found to be an effective means of information dissemination and this traditional form of Out-of-Home advertising has lasted with only minor changes.

The best known form of outdoor signage the billboard, defined as large format advertising displays intended for viewing from extended distances, generally more than 50 feet. Billboards showing static information dominate the market and scatter the landscape. Usually, these huge billboards are raised high above the roadways and display periods last for a minimum of thirty days. It is not effective or economically feasible to change the display content more frequently. Static billboard clients have messages “frozen” in time with high production costs while content may become obsolete before the expiration of the display period. Rotating static billboards may change content, but typically are leased to multiple clients and are cost prohibitive to content modification. In both cases, these outdoor billboards are stationary and rely solely on drive by traffic for circulating the advertising message.

My invention can be classified as a means of Out-of-Home advertising. Transit advertising defined as displays affixed to moving vehicles or in the common areas of transit terminals, stations and airports. Transit displays include: bus panels, taxi panels, and mobile advertising signage. While transit advertising represents big change in the outdoor industry, many of the same disadvantages are inherent in this form of signage as in stationary billboards.

A Mobile Billboard is defined as a truck that is equipped with one or more poster panel units. The trucks can either be parked at specified venues or driven around designated localities. This is a recent development and the use of the static images with changeable content based on a scrolling or rotary system is viewed as advancement. However, major disadvantages remain to be the high production cost for the creation of the static content and the lack of any means to change that content without experiencing great delay in time and financial expenditures. Perhaps more important than cost, is the content limitations. These mobile ad trucks display static images of photos, text or graphics much like any vehicle with a painted or “wrapped” message or display. The only difference is that the mobile ad trucks' content is usually changeable and the display is “for hire” which limits the display capability. The paramount short-coming of the existing mobile ad truck format is their inability to show video content, either real-time or recorded.

### OBJECTS AND ADVANTAGES

Accordingly, my Mobile Digital Media Display System brings unprecedented advantages to the Out-of-Home advertising industry, specifically, the mobile billboard facet of that industry. These electronic signs and those of its kind offer outdoor advertisers tremendous latitude in when and how products and information can be presented to the public. Technology is rapidly moving us to where full video signs will be prevalent as digital signs become commonplace. Stationary Light Emitted Diode video signs can be found throughout the world where only static billboard used to be. The prominence of such full motion video signs in places like Times Square, New York City, Las Vegas and Piccadilly Square, London are indicative of where outdoor signage is headed. This invention will take full motion video advertising to its next logical level. My visionary and forward-looking approach to advertising signage offers a mobile video concept that allows advertisers to take full-motion-digital-video to any desired location, which allows the targeting of any specific demographic at a specified time. The uses for this invention are many and the advantage over the existing static displays on mobile or transit signs is enormous in scope. This invention has potential uses in education, training and entertainment in addition to commercial advertising. The need for large training facilities plus added cost of transporting the trainees is eliminated. This display system takes valuable video training to the field environment. Many of the pre-mission or exercise training programs can now be done on the spot. Special needs long and short term projects such as military recruitment, will also be targeted. School systems, corporate and police training needs may also be served. Through the generation of this bold, new initiative, large and small companies will be served in a way as never before, at a cost remarkably less than any existing medium. Certain businesses like sporting teams, video gaming, movie promotion and video rental by definition have products made to be displayed on large high resolution screens. The Mobile Digital Media Display System combines outdoor signage with television, drive-in movies and the maneuverability of transit advertising.

### SUMMARY

In accordance with the present invention, using opto-electronic devices, full motion digital video images are projected from within a partially or totally enclosed conveyance on to wall-mounted display screens designed for viewing outside the conveyance, while the conveyance is in motion or parked. The general idea of this invention is to remove the barrier of no video or no motion images from mobile or transit displays. The self-contained or modular aspect of this invention allows complete portability and viewing while in transit or on site.

### DRAWINGS

Drawing Figures

FIGS. 1A to 1C show different aspects of the light projection devices and the display screens mounted on the sidewall structures of the “box truck” vehicle.

FIGS. 2A and 2B show different aspects of the light projection device and the display screen mounted on the rear of the “box truck” vehicle.

### REFERENCE NUMERALS IN DRAWINGS

| | |
|---|---|
| 10 truck cab | 12 box truck body |
| 14 projector | 16 translucent side screen |
| 18 box truck side wall | 20 equipment rack |
| 22 translucent rear screen | 24 light image beam |
| 26 mirror | 28 mirror support bracket |
| 30 signal processor | 32 box truck floor |
| 34 door/screen support | 36 metal frame |
| 38 on board power source | 40 generator |

### DETAILED DESCRIPTION

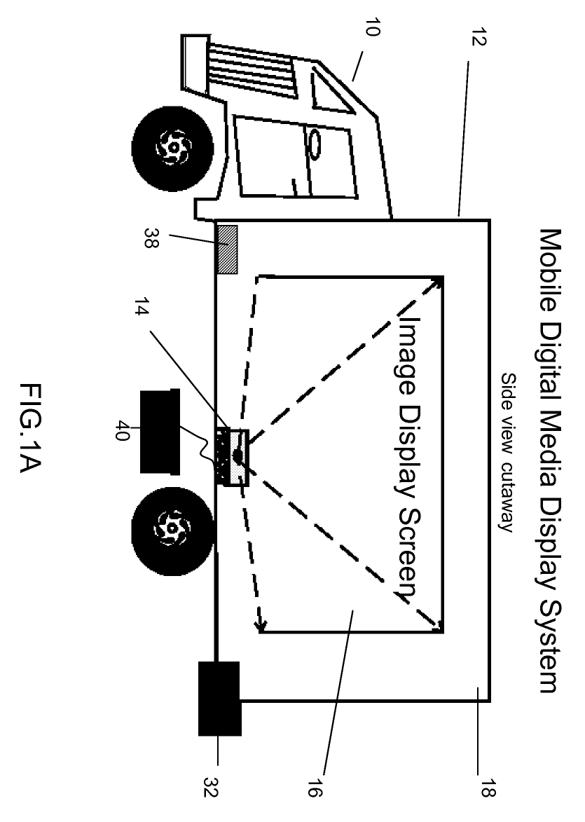

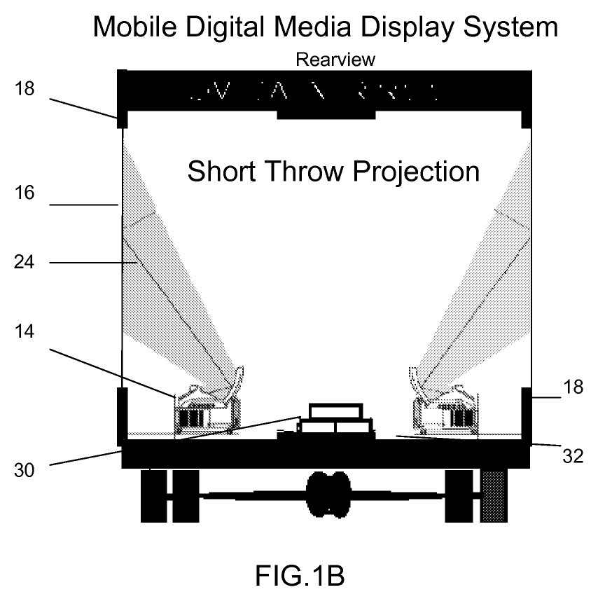

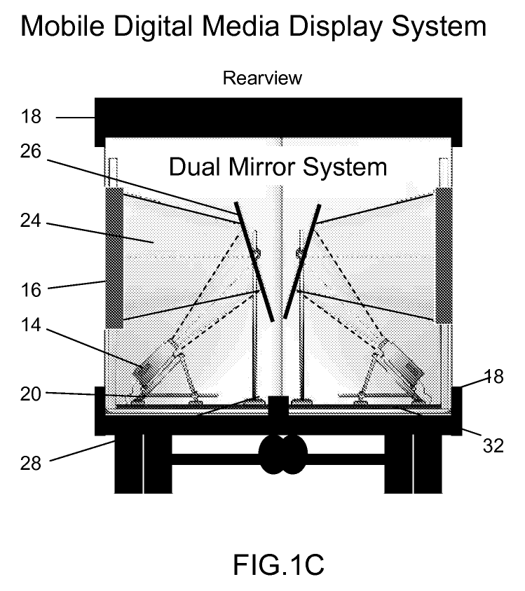

### Description—FIGS. 1A, 1B and 1C-Preferred Embodiment

A preferred embodiment of the present invention is illustrated in FIG. 1A (side view cutaway), FIG. 1B (rearview cutaway of short throw projection) and FIG. 1C (rearview cutaway of dual mirror system). At the core of this invention is the means of conveyance or transit, the box truck shown from a profile perspective 10, 12, 16 and 18. These box trucks are manufactured throughout the world and the primary use has been for the transportation of cargo. For my invention the vehicles of choice are based on the selected screen size (FIG. 1A) and short throw ability (FIG. 1B) of the light projection equipment 14. Engine size and overall vehicle weight are considerations where diesel or gasoline is the fuel source. For this invention, the cargo compartment 12 is modified in such a way that a translucent screen 16 with a supporting frame 36 is installed within the box walls 18. A section of the wall of sufficient size to match the screen 16 size is removed and replaced with the frame 36 and screen 16 material. The present invention is designed for the sidewall 18 installation of one or two display screens 16.

Once the structure of the truck box 12 walls 18 have been changed through the installation of the frame 36 and screen 16 the box must be reinforced for stability. The entire interior of the truck box 12 is painted with flat black paint. Additionally, the floor 32 requires the installation of special energy absorption material for shock dampening. The on board DC to AC power supply 38 may also be located on the floor 32 within the truck box 12. The anti-vibration flooring 32 aids in supporting the equipment rack 20. The stabilized rack holds the signal processor(s) 30 and the light projection equipment 14.

The projectors 14 as seen in FIGS. 1A and 1B may be floor mounted, ceiling mounted or installed in an equipment rack 20. Because of the limited space due to the narrow width of the truck box 12 and the throw ratio needed to create an adequately sized display 16 image, two basic types of projectors 14 are used. The rearview cutaway perspective in FIG. 1B employs a projection device known as a short throw projector 14. These floor 32 mounted projectors 14 each beam 24 images directly on to the two side mounted display screens 16 on opposite sides of the box 12.

Using the perspective and similar configuration seen in FIG. 1B, FIG. 1C uses projectors 14 with conventional throw ratios used in tandem with a mirror refraction system. Here, the projectors 14 are secured on angled supports 20. This configuration also employs a single mirror 26 mounted and stabilized with a sufficiently rigid mirror support bracket 28.

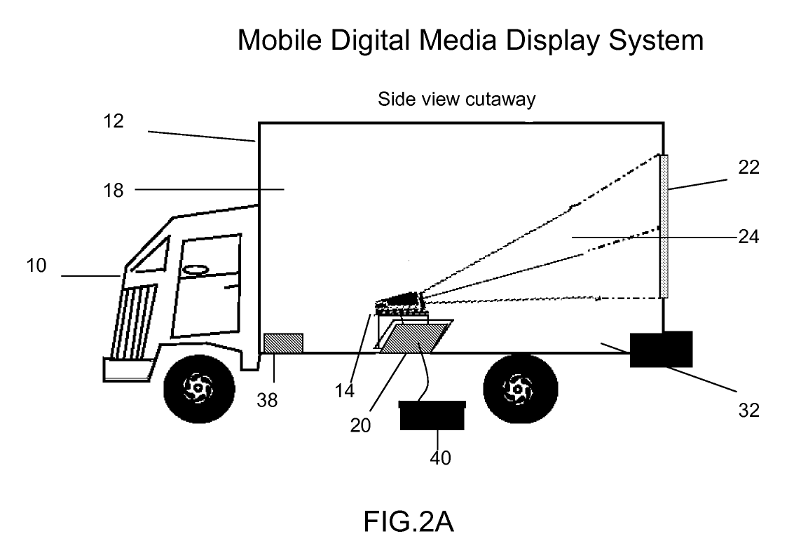

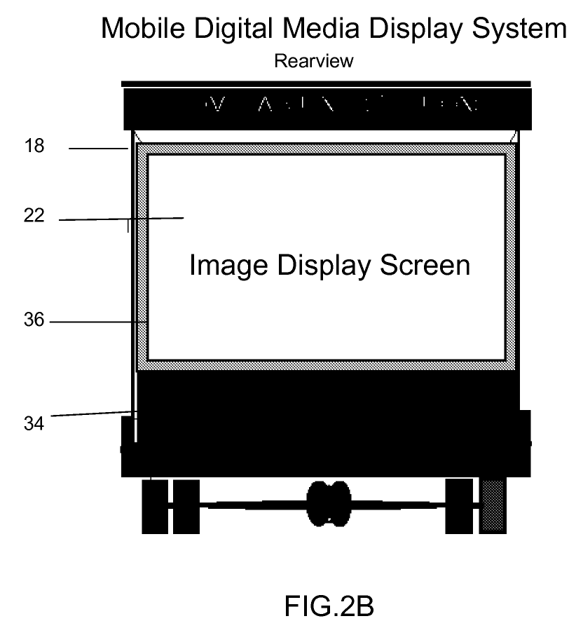

### FIGS. 2A and 2B—Additional Embodiment

The design and perspective of FIG. 2A shows that only one projection device 14 is required in this configuration. Here the regular box truck 12 roll up door is opened and the portable frame 36 and rear translucent display screen 22 is latched to the floor 32, walls 18 and ceiling. Any area not covered by the display screen is enclosed by a fabricated door and screen support 34.This projection unit 14 maybe mounted on the floor 32, ceiling or placed on a support bracket or equipment rack 20.

The perspective in FIG. 2A shows that a long throw or conventional distance projector 14 is adequate here. The placement of the projector 14 allows easy adjustment and generation of a suitable light image beam 24 for the single rear screen 22 as seen in FIG. 2B.

### Advantages

The present invention literally takes high definition video on the road. Current mobile ad trucks can go on location with rotary or scrolling signs, but they can't do video. Light Emitted Diode signs can show video, but can't ride through traffic while it plays. Both represent sizable financial investments. My Mobile Digital Media Display System can deliver video to any outdoor venue and show it in high traffic on the way—at a fraction of the cost.

### Operation—FIGS. 1 and 2

The manner of using the mobile digital media display system a matter of having a basic understanding of light projection equipment. That understanding must include knowledge of angles of view, projection geometry, power requirement and some experience with video and light technology.

Once the setup of the equipment has taken place, video skills regarding image quality or resolution, keystone correction, zoom, focal distance and noise levels move to the front.

The power up sequence begins with the user selected 120 volt AC power source. The system may be operated using any of three sources. For on site stationary applications utility power is recommended. The power requirement for a typical setup with two projectors is 1000 watts continuous. Power requirements increase relative to signal generation, audio and processing equipment consumption

Gasoline or diesel powered generators 40 may also be used in remote sites where utility power may not be accessible. The generator should always be placed in a well ventilated location while in use.

The power source of choice while this mobile display system is used while in transit is the on board power supply 38. This power source consists of a single or multiple deep cycle DC marine batteries connected to an AC power inverter that outputs 120 AC. as a stand alone source. The user may also choose to utilize the box truck's dual heavy duty DC batteries and charging system.

Once the power source is selected, the electronic equipment 14, 30 and signal generation devices may be turned on. When the images 24 are set for the existing viewing circumstances, the vehicle may be driven and the images viewed on the display screens 16, 22 as it moves along the roadway. This feature separates the mobile digital media display system from all other transit and stationary display systems with its ability to show video.

The application potential for this invention is enormous in advertising, education, military, law enforcement and corporate training, recreation and entertainment. Real-time public information services is a great advantage. This display system is ideal for sporting events and gaming. In its simplest terms, the mobile digital media display system is giant high definition TV on wheels. Basic operation can be as easy as turning on home theatre equipment—only it's not home.

### Conclusion, Ramifications, and Scope

Accordingly, the reader can see that the mobile digital media display system can open a new era in media communication. Some of the advantages have been laid out, while others not expressed are limited only by the imagination. This invention represents a resounding leap forward in the outdoor signage industry. More and more as the population becomes more active, more mobile and less likely to read, listen to the radio or watch TV a new way to reach them is desired. Mobile Digital Media Display System offers that new concept.

Though the possible uses for this invention are many, one great advantage factor is the affordable circulation quotient. The costs when compared to conventional means of communication are far less expensive than any other high impact medium.

Users of this system can look for favorable exposure at places like:
Grand Openings
Retail Promotions
Trade Shows
Website Marketing
New Product Roll-Outs
Movie Releases
Political Campaigns
Special Sales Events

The ability of the Mobile Digital Media Display System to deliver customized full motion video, text and slides combines the features of would be competitors, rendering any single entity incomplete. Some other very high visibility uses are:
Sporting Events
Conventions
Shopping and Dining Areas
Theater Districts
Outdoor Festivals
Rush Hour Traffic
Political Campaigns
Video Gaming

According to outdoor advertising magazine, TACA, messages on outdoor mobile trucks has a 97% recall rate and 96% of respondents said that mobile is more effective than traditional outdoor advertising. This trailblazing mobile display system will offer a sensible, competitively priced alternative or complement to TV, radio, newspapers, mailers, static and stationary signage—promising the ultimate impact for marketing budgets of all sizes. No other medium comes close to offering stationary hi-tech digital video advertisement or entertainment. Combined with the mobile element, this invention ushers in a new paradigm that promises to forever change outdoor signage.

Although the description above contains many specifics, these should not be construed as limiting the scope of the invention. Rather, as merely providing illustrations of some of the preferred embodiments of this invention.

I claim:

1-13. (canceled)

14. Any video display device, unit or system which shows images on the side wall or rear surface of or built-in screen of a conveyance that is created or generated with a direct or refracted light device designed for the purpose of the communication of public address, entertainment, training or advertising and is designed for viewing outside said conveyance.

15. The conveyance of claim 14 that uses a light projection device to display moving images of text, graphics, animation or video.

16. The conveyance of claim 14 that is constructed or modified to include partially or totally translucent windows or screens for the purpose of displaying moving images.

17. The conveyance of claim 14 which includes embedded windows or screens used for displaying moving images for viewing from outside said conveyance.

18. The conveyance of claim 14 that uses translucent windows or screens installed within one or both side walls for the purpose of displaying moving images for viewing from outside said conveyance.

19. The conveyance of claim 14 that uses said windows or screens installed on the rear panel or door of said conveyance for the purpose of displaying moving images for viewing from outside said conveyance.

20. The conveyance of claim 14 which uses translucent windows or screens installed within one or both side walls or the rear panel or rear door that is designed for the purpose of displaying moving images for viewing from outside said conveyance.

21. Any electronic system which uses a light projection device to beam moving images from inside a partial or totally enclosed conveyance on to a rear projection screen installed within the walls of said conveyance designed for viewing from outside said conveyance.

22. The electronic system of claim 21 which uses a light projection device to beam moving images directly on to a rear projection screen embedded or installed within the walls of a conveyance designed for viewing from outside said conveyance.

23. The electronic system of claim 21 which uses a light projection device to beam moving images indirectly, using refraction, on to a rear projection screen embedded or installed within the walls of a conveyance designed for viewing from outside said conveyance.

24. The electronic system of claim 21 which uses a light projection device to beam moving images directly on to a rear projection screen embedded or installed within the rear panel or door of a conveyance designed for viewing from outside said conveyance.

25. The electronic system of claim 21 which uses a light projection device to beam moving images indirectly, using refraction, on to a rear projection screen embedded or installed within the rear panel or door of a conveyance designed for viewing from outside said conveyance.

26. Any conveyance which uses solar and or one or more DC batteries mounted onboard, connected to a DC to AC inverter as a power source for electronic equipment used for the projection of moving images from inside said conveyance and displayed on windows or screens built into said conveyance for viewing from outside the conveyance.
